(19) United States
(12) Patent Application Publication
(10) Pub. No.: US 2011/0249641 A1
(43) Pub. Date: Oct. 13, 2011

(54) APPARATUS AND METHOD FOR PERFORMING RANDOM ACCESS IN MULTI-CARRIER SYSTEM

(75) Inventors: Ki Bum KWON, Ansan-si (KR); Myung Cheul JUNG, Seoul (KR)

(73) Assignee: PANTECH CO., LTD., Seoul (KR)

(21) Appl. No.: 13/083,037

(22) Filed: Apr. 8, 2011

(30) Foreign Application Priority Data
Apr. 9, 2010 (KR) 10-2010-0032905

(51) Int. Cl. H04W 72/04

(52) U.S. Cl. 370/329

(57) ABSTRACT

A method for performing a random access in a multi-carrier system includes transmitting a random access preamble on an uplink component carrier to a base station, and receiving a random access response on a first downlink component carrier. The random access response includes information regarding a second downlink component carrier used to transmit a contention resolution message indicating that a random access collision with other mobile stations are resolved. A base station to perform the method includes a preamble reception unit to receive the random access preamble, a response generation unit to generate the random access response, and a response transmission unit to transmit the random access response. A mobile station to perform the method includes a preamble transmission unit, a response reception unit, a carrier configuration unit, and a message reception unit.

### CROSS-REFERENCE TO RELATED APPLICATION

This application claims priority from and the benefit under 35 U.S.C. §119(a) of a Korean Patent Application No. 10-2010-0032905, filed on Apr. 9, 2010, which is incorporated by reference for all purposes as if fully set forth herein.

### BACKGROUND

1. Field

The present description relates to wireless communication and, more particularly, to an apparatus and method for performing random access in a multi-carrier system.

2. Discussion of the Background

In a cellular wireless communication scheme, a plurality of mobile stations (MSs) may be located in a single cell having a base station (BS). In general, an MS undergoes a random access procedure to access a network. The purpose of performing the random access procedure to a network by the MS may be an initial access, handover, scheduling request, timing alignment, and the like.

The random access procedure may be divided into a contention-based random access procedure and a non-contention-based random access procedure. Here, contention refers to attempting a random access procedure by two or more MSs at the same timing by using the same random access preamble. A difference between the contention-based random access procedure and the non-contention-based random access procedure is whether a random access preamble is designated to be dedicated to a single MS. In the non-contention-based random access procedure, an MS uses a random access preamble dedicated to the MS itself, so a contention (or a collision) with a different MS does not occur. In the contention-based random access procedure, the MSs use an arbitrarily selected random access preamble, resulting in the possibility of contention.

In a general wireless communication system, only a single carrier may be considered although bandwidths between uplink and downlink are set to be different. Under the 3GPP (3^{rd} Generation Partnership Project) LTE (long term evolution), the number of carrier constituting uplink and downlink is 1, and the bandwidth of uplink and the bandwidth of downlink are generally symmetrical. In such a single carrier system, random accessing is performed by using a single carrier. However, in a multi-carrier system, random accessing can be implemented through several component carriers.

The multi-carrier system refers to a wireless communication system capable of supporting carrier aggregation. Carrier aggregation refers to a technique of using fragmented small bands, in which physically non-continuous bands in a frequency domain are grouped to obtain an effect as if logically large bands were used. The carrier aggregation includes, for example, under the 3GPP LTE, although it supports a maximum 20 MHz bandwidth, a technique for supporting a 100 MHz system bandwidth by using multiple carriers, and a technique for allocating an asymmetrical bandwidth between uplink and downlink.

The introduction of the multi-carrier system allows for using multiple component carriers in random accessing. However, in performing random access in the multi-carrier system, information transmitted to each of the component carriers or the relationship between component carriers has not been determined.

### SUMMARY

Exemplary embodiments of the present invention provide an apparatus and a method for performing random access in multi-carrier system.

Exemplary embodiments of the present invention also provide an apparatus and a method for configuring a message including information regarding a random access suspension in a multi-carrier system.

Exemplary embodiments of the present invention also provide an apparatus and a method for transmitting and receiving a message including information regarding a random access suspension in a multi-carrier system.

Exemplary embodiments of the present invention also provide an apparatus and a method for performing a dynamic random access procedure in a multi-carrier system.

Exemplary embodiments of the present invention also provide an apparatus and a method for performing a random access procedure through an alternate component carrier in a multi-carrier system.

Exemplary embodiments of the present invention also provide an apparatus and a method for performing a high speed random access procedure in a multi-carrier system.

Additional features of the invention will be set forth in the description which follows, and in part will be apparent from the description, or may be learned by practice of the invention.

Exemplary embodiments of the present invention provide a method for performing a random access by a first mobile station in a multi-carrier system. The method includes transmitting a first random access preamble on a first uplink (UL) component carrier (CC) to a base station (BS), and receiving a random access response (RAR) on a first downlink (DL) CC linked to the first UL CC. The RAR includes information regarding a second DL CC, and the second DL CC is used to transmit a contention resolution (CR) message indicating that a random access collision with a second mobile station is resolved.

Exemplary embodiments of the present invention provide a method for performing a random access by a base station (BS) in a multi-carrier system. The method includes receiving a first random access preamble on an uplink (UL) component carrier (CC) from a first mobile station (MS), transmitting a random access response (RAR) on a first downlink (DL) CC linked to the UL CC, receiving an uplink message from the first MS on a UL resource indicated by the RAR, and transmitting a contention resolution (CR) message on a second DL CC, the CR message indicating that a collision of the first random access preamble and a second random access preamble of a second MS is resolved. The RAR includes information regarding the second DL CC.

Exemplary embodiments of the present invention provide a base station (BS) to perform a random access in a multi-carrier system. The BS includes a preamble reception unit to receive a first random access preamble on a first uplink (UL) component carrier (CC) from a first mobile station (MS) performing a first random access, a response generation unit to generate a random access response (RAR) including first information and second information, the first information to suspend a second random access if the first random access is not successful, the second information identifying a second UL CC to perform the second random access if the second random access is triggered, and a response transmission unit to transmit the RAR to the first MS by using a first downlink (DL) CC linked to the first UL CC.

Exemplary embodiments of the present invention provide a first mobile station (MS) to perform a random access in a multi-carrier system. The first MS includes a preamble transmission unit to transmit a first random access preamble on a first uplink (UL) component carrier (CC) to a base station (BS), a response reception unit to receive a random access response (RAR) on a first downlink (DL) CC linked to the first UL CC, a carrier configuration unit to set a second DL CC, and a message reception unit to receive a contention resolution (CR) message on the second DL CC, the CR message indicating a resolution of a collision of the first random access preamble and a separate random access preamble of a second MS. The RAR includes information regarding the second DL CC.

It is to be understood that both foregoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an exemplary wireless communication system.

FIG. 2 shows an example of a protocol structure for supporting multiple carriers.

FIG. 3 illustrates an example of a frame structure for operating multiple carriers.

FIG. 4 illustrates a linkage between downlink component carriers and uplink component carriers in the multi-carrier system.

FIG. 5 is a flow chart illustrating a process for performing random access.

FIG. 6 is a flow chart illustrating a method for performing random access according to an exemplary embodiment of the present invention.

FIG. 7 shows a message format of the information regarding a random access suspension according to an exemplary embodiment of the present invention.

FIG. 8 is a flow chart illustrating a method for performing a random access according to an exemplary embodiment of the present invention.

FIG. 9 is a flow chart illustrating a method for performing a random access according to an exemplary embodiment of the present invention.

FIG. 10 is a flow chart illustrating a method for performing a random access according to an exemplary embodiment of the present invention.

FIG. 11 is a flow chart illustrating a first portion of a method for performing a random access according to an exemplary embodiment of the present invention.

FIG. 12 is a flow chart illustrating a second portion of the method of FIG. 11 for performing a random access according to an exemplary embodiment of the present invention.

FIG. 13 is a flow chart illustrating a method for performing a random access according to an exemplary embodiment of the present invention.

FIG. 14 is a flow chart illustrating a method for performing a random access according to an exemplary embodiment of the present invention.

FIG. 15 is a schematic block diagram showing a base station and a mobile station to perform a random access according to an exemplary embodiment of the present invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

In the disclosure, terms such as first, second, A, B, (a), (b), etc., may be used. Such terms are used for merely discriminating the corresponding elements from other elements. The corresponding elements are not limited in their essence, sequence, or precedence by the terms.

In the disclosure, a wireless communication network will be described, and an operation performed in the wireless communication network may be performed in a component (e.g., a base station (BS)) of the system administering the wireless communication network to control the network and to transmit data, or may be performed in a mobile station (MS) connected to the corresponding wireless network.

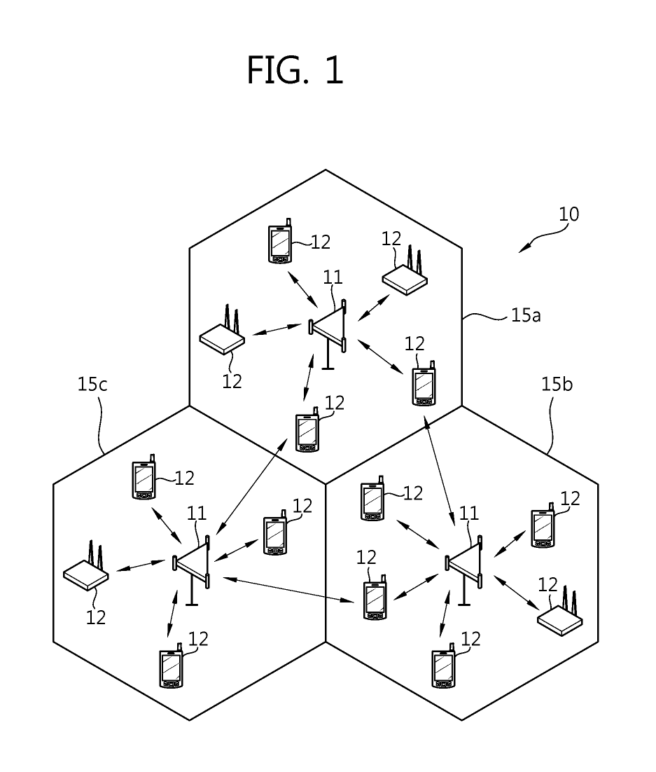

FIG. 1 illustrates an exemplary wireless communication system.

With reference to FIG. 1, the wireless communication system 10 is widely disposed to provide various communication services such as voice and packet data, or the like. The wireless communication system 10 includes at least one base station (BS). A BS 11 provides a communication service to a particular geographical area or a frequency area, which is referred to herein as a cell. Cells 15a, 15b, and 15c are shown in FIG. 1. A cell may be divided into areas, which are referred to herein as sectors.

A mobile station (MS) 12 may be a fixed or mobile device having wireless capabilities and may be referred to by other names such as user equipment (UE), mobile terminal (MT), user terminal (UT), subscriber station (SS), wireless device, personal digital assistant (PDA), wireless modem, handheld device, etc. The BS 11 generally refers to a fixed station that communicates with the MS 12 and may be called by other names such as evolved-node B (eNB), base transceiver system (BTS), access point (AP), etc. Cells 15a, 15b, and 15c may indicate partial areas covered by the BS 11, and may include various coverage areas such as a mega-cell, a macro-cell, a micro-cell, a pico-cell, a femto-cell, and the like.

Hereinafter, downlink (DL) refers to communication from the BS 11 to the MS 12, and uplink (UL) refers to communication from the MS 12 to the BS 11. In the downlink, a transmitter may be a part of the BS 11 and a receiver may be a part of the MS 12. In the uplink, a transmitter may be a part of the MS 12 and a receiver may be a part of the BS 11. Multi-access schemes applied to the wireless communication system are not limited. Namely, various multi-access schemes such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA, or the like, may be used. A TDD (Time Division Duplex) scheme in which transmission is made by using a different time or an FDD (Frequency Division Duplex) scheme in which transmission is made by using different frequencies may be applied to an uplink transmission or a downlink transmission.

A carrier aggregation (CA) supports a plurality of carriers, which is also called a spectrum aggregation or a bandwidth aggregation. Individual unit carriers grouped through carrier aggregation are called component carriers. Each of the component carriers is defined as bandwidth and central frequency. The carrier aggregation is introduced and may support increased throughput, may prevent or reduce an increase in cost otherwise caused by an introduction of a broadband radio frequency (RF) element, and may offer or guarantee compatibility with an existing system. For example, when five component carriers are allocated as granularity of carrier unit having a 20 MHz bandwidth, a maximum 100 MHz bandwidth can be supported.

The carrier aggregation can be divided into a contiguous carrier aggregation made among component carriers that are consecutive in a frequency domain, and a non-contiguous carrier aggregation made among component carriers that are inconsecutive the frequency domain. An aggregation in which the number of downlink component carriers is equal to the number of uplink component carriers is called a symmetric aggregation, and an aggregation in which the number of downlink component carriers is unequal to the number of uplink component carriers is called an asymmetric aggregation.

Sizes (i.e., bandwidths) of component carriers may vary. For example, when five component carriers are used to configure a 70 MHz band, the five carriers may be configured as follows: 5 MHz carrier (carrier #0)+20 MHz carrier (carrier #1)+20 MHz carrier (carrier #2)+20 MHz carrier (carrier #3)+5 MHz carrier (carrier #4).

Hereinafter, a multi-carrier system refers to a system supporting the carrier aggregation. In the multi-carrier system, the contiguous carrier aggregation and/or a non-contiguous carrier aggregation may be used, and the symmetrical aggregation and/or the asymmetrical aggregation may be used.

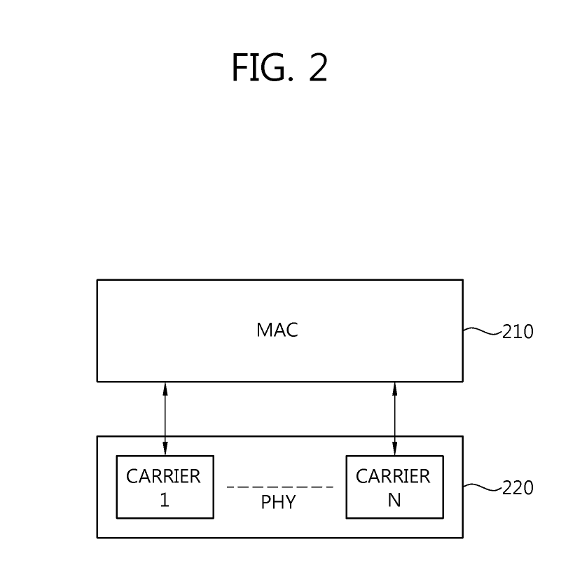

FIG. 2 shows an example of a protocol structure for supporting multiple carriers.

With reference to FIG. 2, a common medium access control (MAC) entity 210 manages a physical (PHY) layer 220 using a plurality of carriers. A MAC management message transmitted in a particular carrier may be applied to a different carrier. Namely, the MAC management message, including a particular carrier, can control other carriers. The PHY layer 220 may operate according to TDD (Time Division Duplex) and/or FDD (Frequency Division Duplex).

Some physical control channels are used in the PHY layer 220. A PDCCH (physical downlink control channel) allocates resources of PCH (paging channel) and DL-SCH (downlink shared channel) to the MS and provides HARQ (hybrid automatic repeat request) information related to a DL-SCH. The PDCCH may carry an uplink grant informing the MS about an uplink resource allocation. A PCFICH (physical control format indicator channel) informs the MS about the number of OFDM symbols used for the PDCCHs, and is transmitted at each subframe. A PHICH (physical Hybrid ARQ Indicator Channel), a response to an uplink transmission, carries an HARQ ACK/NAK signal. A PUCCH (Physical uplink control channel) carries a HARQ ACK/NAK signal with respect to a downlink transmission, a scheduling request, and uplink control information such as CQI, or the like. A PUSCH (Physical uplink shared channel) carries an UL-SCH (uplink shared channel).

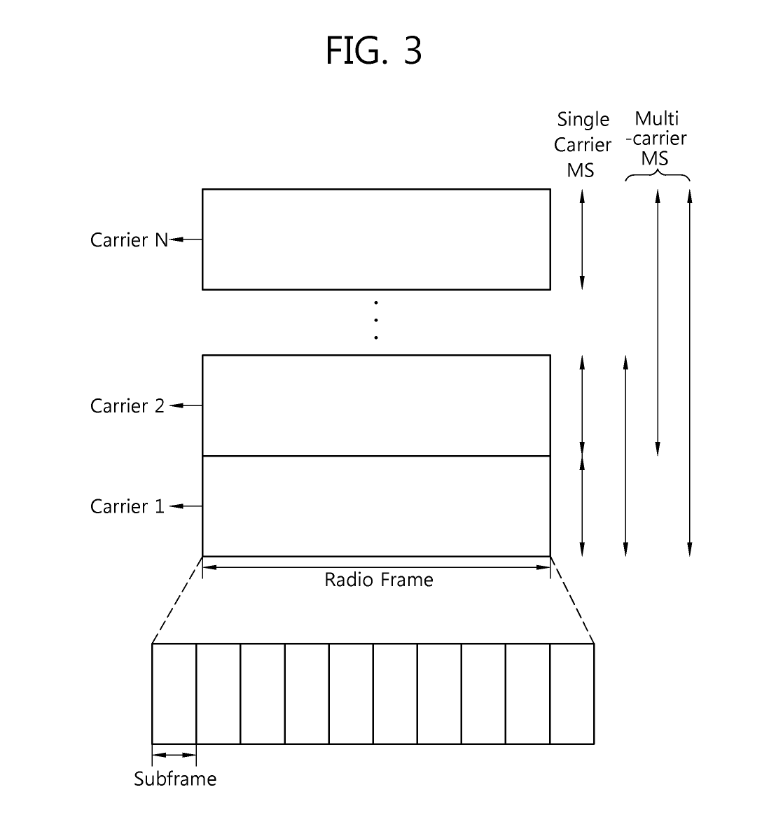

FIG. 3 illustrates an example of a frame structure for operating multiple carriers.

A frame includes 10 subframes. Each of the subframes may contain a plurality of OFDM symbols. Each carrier may have its own control channel (e.g., a PDCCH). Multiple carriers may or may not be adjacent to each other. The MS may support one or more carriers according to its capability.

Component carriers may be divided into a fully configured carrier and a partially configured carrier according to directionality. The fully configured carrier is a bi-directional carrier for transmitting and/or receiving control signal and data, and the partially configured carrier is a uni-directional carrier for transmitting only downlink data. The partially configured carrier may be largely used for a multicast broadcast service (MBS) and/or a single frequency network (SFN).

Component carriers may be divided into a primary component carrier and a secondary component carrier according to activation status. The primary component carrier is a constantly activated carrier, and the secondary carrier is a carrier which is activated or deactivated according to particular conditions. Here, activation refers to a state in which traffic data is transmitted or received or a state in which traffic data is ready to be transmitted or received. Deactivation refers to a state in which traffic data cannot be transmitted or received and measurement or transmission or reception of minimum information is available. The MS may use one primary component carrier, or may use one or more secondary component carriers along with a primary component carrier. The BS may allocate the primary component carrier and/or the secondary component carrier(s) to the MS. The primary component carrier may be a fully configured component carrier, through which major control information between the BS and the MS is exchanged. The secondary component carrier may be a fully configured carrier or a partially configured carrier, which is allocated according to a request from the MS or according to an instruction of the BS. The primary component carrier may be used for a network entry of the MS and/or an allocation of the secondary component carrier. The primary component carrier may not be a fixed carrier but can be selected from among fully configured carriers. A carrier set as the secondary carrier may be changed to the primary carrier.

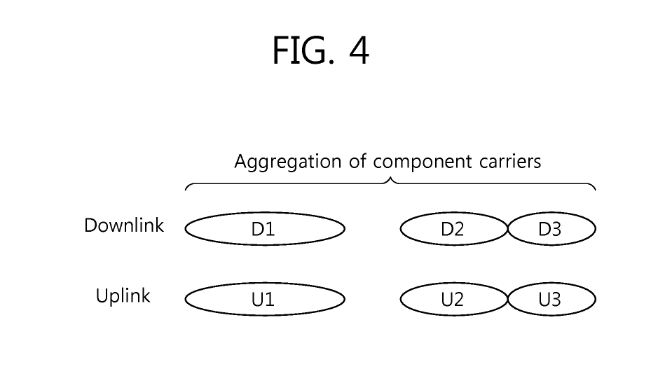

FIG. 4 illustrates a linkage between downlink component carriers and uplink component carriers in the multi-carrier system.

With reference to FIG. 4, downlink component carriers D1, D2, and D3 are aggregated in downlink, and uplink component carriers U1, U2, and U3 are aggregated in uplink. Here, Di is an index (i=1, 2, 3) of the downlink component carriers, and Ui is an index of uplink component carriers. At least one downlink component carrier is a primary component carrier, and the other remaining downlink carriers are secondary component carriers. Similarly, at least one uplink component carrier is a primary component carrier, and the other remaining uplink carriers are secondary component carriers. For example, D1 and U1 may be primary component carriers, and D2, U2, D3, and U3 may be secondary component carriers.

In an FDD system, the downlink component carriers D1, D2, and D3 and the uplink component carriers U1, U2, and U3 are set to be connected by 1:1, and in this case, D1 is set to be connected to U1, D2 to U2, and D3 to U3, in a one-to-one manner. The MS sets the connection between the downlink component carriers and the uplink component carriers through system information transmitted by a logical channel BCCH or an MS-dedicated radio resource control (RRC) message transmitted by a downlink control channel (DCCH). Each connection may be set to be specific to a cell or may be specific to an MS.

An example of uplink component carriers set to be connected to downlink component carriers is as follows: 1) An uplink component carrier for transmitting ACK/NACK information by the MS with respect to data transmitted by the BS through a downlink component carrier; 2) A downlink component carrier for transmitting ACK/NACK information by the BS with respect to data transmitted by the MS through the uplink component carrier; 3) a downlink component carrier for transmitting a response when the BS receives a random access preamble (RAP) transmitted through an uplink component carrier by the MS starting a random access procedure; and 4) an uplink component carrier to which uplink control information is applied when the BS transmits the uplink control information through a downlink component carrier.

FIG. 4 illustrates only the one-to-one connection set between the downlink component carriers and the uplink component carriers, but alternatively a connection setting of 1:n or n:1 may be also established between the downlink component carriers and the uplink component carriers. Also, an index of the component carriers may not be consistent with the order of component carriers or the position of a frequency band of a corresponding component carrier.

A primary serving cell refers to a serving cell providing a security input and Non-access stratum (NAS) mobility information in a state in which an RRC is established or re-established. At least one cell may be configured to form a set of serving cells along with a primary serving cell according to capabilities of the MS, and in this case, the at least one cell is called a secondary service cell.

Thus, the set of serving cells configured for one MS may include only a single primary serving cell or may include one primary serving cell and one or more secondary serving cells.

A downlink component carrier corresponding to a primary serving cell is called a downlink primary component carrier (DL PCC), and an uplink component carrier corresponding to a primary serving cell is called an uplink primary component carrier (UL PCC). Also, in downlink, a component carrier corresponding to a secondary serving cell is called a downlink secondary component carrier (DL SCC), and in uplink, a component carrier corresponding to a secondary serving cell is called an uplink secondary component carrier (UL SCC). The downlink component carrier only may correspond to one serving cell, or the downlink component carrier and the uplink component carrier may correspond together to one serving cell.

A random access procedure will now be described in more detail. The MS performs random access to the BS according to various conditions. For example, the MS may perform random access to the BS: 1) when a state is changed (from RRC_IDLE to RRC_CONNECTED), 2) when an RRC connection is re-established, 3) when the MS receives downlink data in a state in which the MS fails to secure uplink synchronization, 4) when data is generated to be transmitted to uplink in a state in which the MS fails to secure uplink synchronization, 5) when there is no resource for transmitting a scheduling request (SR) although data is generated to be transmitted to uplink in a state in which the MS has secured uplink synchronization, 6) when a transmission of the scheduling request has reached a maximum re-transmission number although data to be transmitted to uplink has been generated in a state in which the MS has secured uplink synchronization, or 7) the MS is newly connected to the network through handover, or the like. However, these examples are merely illustrative, and the purpose of performing random access may vary in the number or content according to systems.

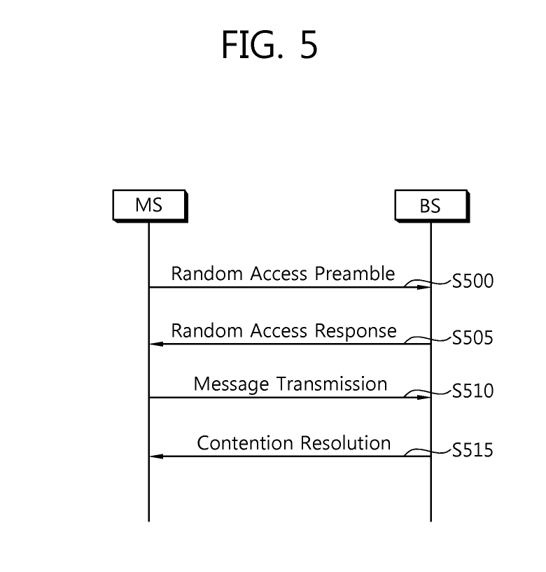

FIG. 5 is a flow chart illustrating a process for performing random access.

With reference to FIG. 5, first, the MS randomly selects a preamble signature and transmits a random access preamble generated based on the preamble signature to the BS (S500). The selection of the preamble signature may be performed based on contention. A contention-free method may be also used. In this case, the BS informs the MS about a previously reserved random access preamble, and the corresponding MS transmits a preamble selected based on received information to the BS (not shown). In this case, a procedure such as a transmission of a message in the contention-based method may not be performed in the contention-free method. The MS may recognize RA-RNTI (Random Access-Radio Network Temporary Identifier) in consideration of a preamble selection or frequency resource temporarily selected for a random access and a transmission point in time.

Upon receiving the preamble from the MS, the BS transmits a random access response (RAR) to the MS (step S505). The random access response is transmitted through a physical downlink shared channel (PDSCH). The random access response may include identification information of the MS preamble received by the BS, an identification (ID) of the BS, a temporary C-RANI (Cell Radio Network Temporary Identifier), information regarding a time slot during which the MS preamble has been received, a random access channel (RACH) stop indicator and parameter, timing offset information (or timing advance (TA) information), information regarding an allocation of radio resource of uplink for a transmission of an RRC connection request message, and the like. Since timing information for uplink synchronization is received through the random access response, the MS can perform uplink synchronization with the BS.

The MS performs L2/L3 message transmission at a determined schedule point in time by using the TA information included in the random access response (S510). The message transmission is performed through physical uplink shared channel (PUSCH), or HARQ (Hybrid Automatic Repeat reQuest) may be also performed. The message may include an RRC connection request, a tracking area update, a scheduling request, or the like. Also, one of the messages may include a temporary C-RNTI (Cell-RNTI), a C-RNTI (when the MS already has one as a unique identifier of the particular MS), MS Identification information, or the like.

After receiving the message from the MS, the BS transmits a contention resolution (CR) message to the MS (S515). The CR message indicates that an access collision with other MSs has been resolved or includes information to resolve a collision between a random access preamble by a different MS and the MS. This is because a collision may occur in one or more of steps S500, S505, and S510. The contention resolution message may have an independent message format or may be merged with the RRC message. The contention resolution message is based on the C-RNTI in a PDCCH of a primary serving cell (PCell) or MS contention resolution identification information in a downlink common channel as a transport channel.

The MS may check that the contention resolution message is for the MS and transmits ACK, or 2) it may check that the contention resolution message is for a different terminal and do not transmit response data. If the MS does not properly receive a downlink allocation or if the MS fails to decode the contention resolution message, the MS does not transmit response data in response to the contention resolution message.

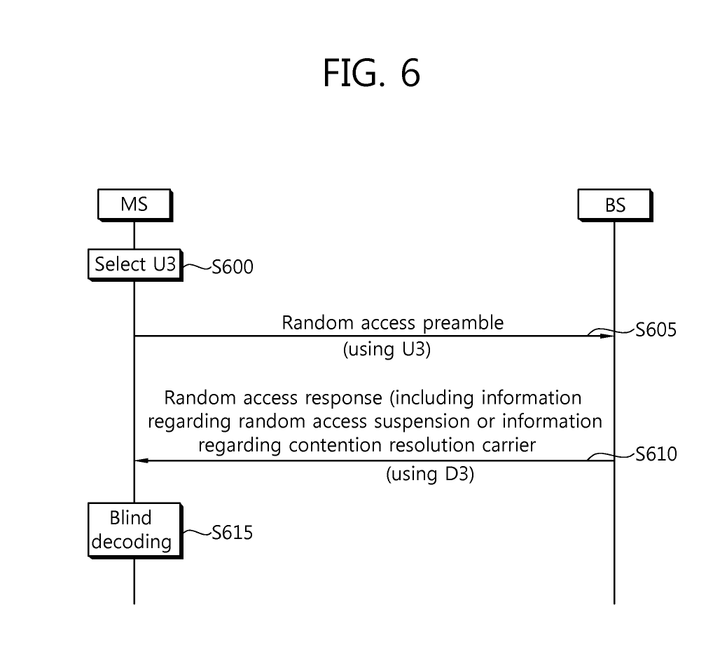

FIG. 6 is a flow chart illustrating a method for performing random access according to an exemplary embodiment of the present invention. Here, it is assumed that the downlink component carriers D1, D2, and D3 are aggregated through carrier aggregation, and the uplink component carriers U1 U2, and U3 are aggregated through carrier aggregation. Also, D1 and U1 are a downlink primary component carrier and an uplink primary component carrier, respectively. For example, D1 and U1 may be linked to configure a primary serving cell. D2 and U2 may be linked to configure a first secondary serving cell, and D3 and U3 may be linked to configure a second secondary serving cell. Thus, the concept that communication between the MS and the BS is made through downlink component carrier (DL CC) or uplink component carrier (UL CC) in the carrier system is similar to transmitting a preamble by using a primary serving cell or a secondary serving cell. Also, the concept that the MS receives downlink information by using the DL CC is similar to receiving downlink information by using a primary serving cell or a secondary serving cell.

In the following description, it is assumed that communication between the MS and the BS is made through a CC.

With reference to FIG. 6, the MS selects an uplink CC U3 from among U1, U2, and U3 for transmitting a random access preamble (S600). In selecting the UL CC, the following conditions may be considered: 1) whether synchronization of the UL CC is not secured, such that the U1 is a UL PCC, synchronization is secured, and the synchronization of U1 can be equally applied to U2, but TA information of U3 is different from that of U1; 2) which UL CC may perform random access more quickly at a current point in time when random access is required; 3) which UL CC has the larger amount of time and/or frequency resources available for transmitting a random access preamble in an initial random access procedure; 4) whether there is no extract resource in a PUCCH of UL CL for transmitting a scheduling request although a message of a MAC layer, such as the scheduling request, is transmitted; and 5) whether ‘information for selecting UL CC for performing random access’ received from the BS is used, and the like.

The MS transmits the random access preamble to the BS by using the selected UL CC U3 (S605). The random access preamble may be generated based on a randomly selected preamble signature. The MS selects a preamble type based on a RACH parameter, a time at which the random access preamble is to be transmitted, and/or frequency resources, and transmits the same. In this case, the MS and the BS may generate an RA-RNTI (Random Access-RNTI) value based on information regarding time and/or frequency resources by which the random access preamble has been transmitted. The BS scrambles CRC (Cyclic Redundancy Check) parity bits of a PDCCH with the generated RA-RNTI value. The scrambling is also called masking. An RNTI, a unique identifier, is scrambled in the CRC according to the owner or purpose of the PDCCH. When the PDCCH is for a particular MS, a unique identifier of the particular MS, e.g., a C-RNTI (Cell-RNTI), may be scrambled in the CRC, and when the PDCCH is for a random access, an RA-RNTI is scrambled in the CRC.

The BS transmits a random access response (RAR) to the MS by using the DL CC D3 linked to U3 (S610). The RAR is included in a PDSCH, and information regarding the PDSCH and control information are included in the PDCCH. The RAR may include identification information of the MS preamble received by the BS, an identification (ID) of the BS, a temporary C-RANI (Cell Radio Network Temporary Identifier), information regarding a time slot during which the MS preamble has been received, an RACH stop indicator and parameter, timing offset information (or timing advance (TA) information), information regarding an allocation of radio resource of uplink for a transmission of an RRC connection request message, information regarding contention resolution (CR) carrier, DL CC scheduled for transmitting a CR message later, and/or information regarding a random access suspension. The information regarding a CR carrier and the information regarding the random access suspension will be described in more detail below.

Meanwhile, the MS receives the random access response using D3 within a random access response window section, which may be previously established. After receiving the random access response, the MS performs blind decoding (S615).

Blind decoding refers to a decoding scheme in which the MS monitors a set of PDCCH candidates in a subframe to discover its PDCCH. Here, monitoring refers to attempting decoding on each PDCCH candidate by the MS according to the format of downlink control information. The reason for performing blind decoding is because the BS does not provide and the MS does not receive information regarding where a PDCCH for a particular MS exists. After demasking the PDCCH by using the RA-RNTI, if a CRC error is not detected, the MS may detect a PDCCH having its DCI (Downlink Control Information). Various RNTIs may be used for blind decoding. For example, a P-RNTI (Paging-RNTI), a C-RNTI (Cell-RNTI) related to a particular transmission of the MS, an RA-RNTI related to a random access, and the like, may be used.

An operation after the MS receives the RAR differs according to whether the RAR includes information regarding a random access suspension. In the following description, the operation after the MS receives the RAR is divided into a case (I) in which the RAR includes the information regarding a random access suspension and a case (II) in which the RAR does not include the information regarding a random access suspension.

I. When RAR Includes Information Regarding Random Access Suspension

The random access may be suspended in the various following cases: 1) When mutual interference between random access preambles is high in a state in which the BS receives the random access preamble of the MS; 2) When there is no available resource for performing a random access; and 3) when it is determined that a random access of the corresponding MS cannot be performed for the reason of a network limitation, or the like. The respective cases may be triggering conditions for suspending the random access.

Thus, if the random access using a particular UL CC is to be suspended, the BS includes information regarding a random access suspension in the RAR and transmits the same to the MS.

The MS may perform a follow-up procedure of suspending the random access with reference to the information regarding the random access suspension, or proceeding with it. For example, the information regarding the random access suspension may be information for directly triggering performing or suspending a random access. In one case, the MS may perform or suspend a random access after it receives the information regarding the random access suspension. In another example, the information regarding the random access suspension may be suspending configuration information. In this case, the MS may set an operation to be performed in the occurrence of the random access suspension based on the suspending configuration information. Thereafter, if performing or suspending a random access is triggered, the MS may attempt a new random access or may suspend the random access according to the suspending configuration information.

The information regarding the random access suspension may include at least one of an access suspending indicator, a suspending parameter, and alternative carrier information. The suspending parameter and the alternative carrier information are an example of the suspending configuration information. When multiple MSs transmit a random access preamble through the same time and/or frequency resource of the same UL CC, they may have the same RA-RNTI value. Thus, all MSs may equally receive information regarding the random access suspension.

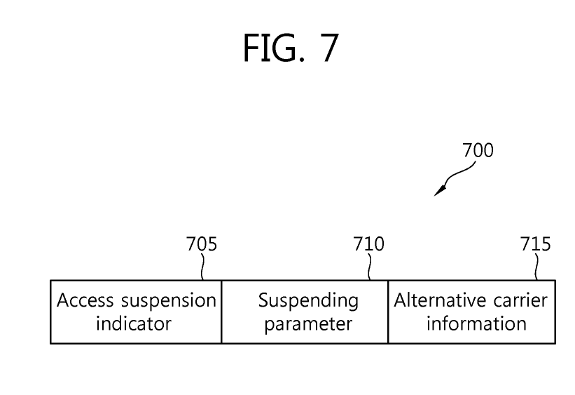

FIG. 7 shows a message format of the information regarding a random access suspension according to an exemplary embodiment of the present invention.

With reference to FIG. 7, information regarding the random access suspension may include at least one of an access suspension indicator 705, a suspending parameter 710, and alternative carrier information 715, and may be configured in the form of MAC control information. In particular, these may be configured as a MAC subheader 700.

For example, the MAC subheader 700 includes a 1-bit type discrimination indicator for discriminating whether or not the MAC subheader 700 includes the access suspension indicator 705 or includes information regarding an ID of a random access preamble. For example, if the type discrimination indicator is 0, the MAC subheader 700 includes the access suspension indicator 705, and if the type discrimination indicator is 1, the MAC subheader 700 includes information regarding an ID of a random access preamble. The indications of the type discrimination indicator may be interchanged.

And, if the type discrimination indicator is 0, the MAC subheader 700 indicates to update the information regarding the access suspension indicator without indicating a suspension of an access.

On the other hand, if the type discrimination indicator is 1, the MAC subheader 700 indicates suspension of access. In this case, if the Tables 1, 2 and 3 below include the corresponding information regarding the access suspension indicator, the UE performs access suspension referring to the indices in the tables.

When the type discrimination indicator indicates inclusion of the access suspension indicator 705, the MAC subheader 700 may further include the 4-bit suspending parameter 710 and the 3-bit alternative carrier information 715. The access suspension indicator 705, the suspending parameter 710, and the alternative carrier information 715 may be expressed as continuously configured payload.

First, the access suspension indicator 705 is information for identifying overload condition in a particular UL CC or a cell. Namely, the access suspension indicator 705 indicates a suspension of a random access in a particular UL CC or in a cell because an excessive random access takes place in the particular UL CC or in the cell. The access suspension indicator 705 may be expressed as a subheader of MAC control information. The access suspension indicator may be also called a backoff indicator.

The suspending parameter 710 configures a suspension of a random access.

For example, the suspending parameter 710 includes information regarding a suspending time. The suspending time refers to a certain time during which a random access may be suspended in a particular cell or in a UL CC. For example, if the suspending time is 100 ms, the MS selects a certain backoff time according to a uniform distribution within 0 to 100 ms, and suspends a random access transmission by the backoff time.

Besides, the suspending time may be used as a determination condition for triggering a random access. For example, if the suspending time is greater than or equal to a threshold value, a random access is not triggered, so the MS suspends a transmission of a random access. Conversely, if the suspending time is smaller than the threshold value, a random access is triggered and the MS may re-attempt a random access, and may re-attempt the random access through a different UL CC.

Table 1 below shows an example of the suspension parameter 710. It shows a case in which the suspension parameter 710 includes only information regarding a suspending time.

TABLE 1

| Index | Suspending parameter |
|---|---|
| 0 | 0 ms |
| 1 | 10 ms |
| 2 | 20 ms |
| 3 | 30 ms |
| 4 | 40 ms |
| 5 | 60 ms |
| 6 | 80 ms |
| 7 | 120 ms |
| 8 | 160 ms |
| 9 | 240 ms |
| 10 | 320 ms |
| 11 | 480 ms |
| 12 | 960 ms |

With reference to Table 1, a suspending time of a random access from the indexes 0 to 12 is represented by ms. For example, if the index of the suspending parameter 710 is 7, every MS receiving it does not perform a random access through a UL CC regarding a particular cell for 120 ms. The suspending parameter 710 may indicate any one of the indexes 0 to 12, and it may be composed of 4 bits in order to represent any of the indexes. A mapping relationship between the indexes and the suspending time of the suspending parameter 710 may be previously known between the BS and the MS, or may be information provided by the BS to the MS.

In another example, the suspending parameter 710 may include information regarding a combination of a suspending time and suspending objects. The suspending object discriminates whether or not a random access is suspended for a specific MS, whether it is suspended for a specific UL CC, or it is suspended for a specific carrier type. For example, if the suspending parameter 710 is a particular index value or lower, the suspending object may be a cell-specific linked CC, and if the suspending parameter is greater than the particular index value, the suspending object may be an MS-specific linked CC (referred to below as a UE-specific linked CC).

Table 2 below shows another example of the suspending parameter 710. In this case, the suspending parameter 710 includes information regarding a combination of a suspending time and suspending objects.

TABLE 2

| Index | Suspending parameter | |
|---|---|---|
| 0 | 0 ms | |
| 1 | 10 ms | |
| 2 | 20 ms | |
| 3 | 30 ms | |
| 4 | 40 ms | |
| 5 | 60 ms | |
| 6 | 80 ms | |
| 7 | 120 ms | |
| 8 | 160 ms | |
| 9 | 240 ms | |
| 10 | 320 ms | |
| 11 | 480 ms | |
| 12 | 960 ms | |
| 13 | 960 ms | Cell-specific linked CC |
| 14 | 960 ms | UE-specific linked CC |
| 15 | 960 ms | Primary component |
| | | carrier (PCC) |

With reference to Table 2, the suspending parameter 710 of the indexes 0 to 12 includes only the information regarding a suspending time, and the suspending parameter 710 of the indexes 13 to 15 includes information regarding a combination of a suspending time and suspending objects. When the MS receives the indexes 13, 14, or 15 of the suspending parameter 710, it suspends a random access procedure in the UL CC indicated by the corresponding index for 960 ms.

The mapping relationship between the indexes and the suspending time/suspending objects of the suspending parameter 710 may be previously known between the BS and the MS, or may be information provided by the BS to the MS.

Table 3 below shows still another example of the suspending parameter 710. It shows a case in which the suspending parameter 710 includes information regarding a combination of a suspending time and suspending objects.

TABLE 3

| | Suspending parameter | |
|---|---|---|
| Index | Suspending time | Suspending object |
| 0 | 0 ms | Cell-specific linked CC |
| 1 | 10 ms | Cell-specific linked CC |
| 2 | 30 ms | Cell-specific linked CC |
| 3 | 90 ms | Cell-specific linked CC |
| 4 | 160 ms | Cell-specific linked CC |
| 5 | 320 ms | Cell-specific linked CC |
| 6 | 960 ms | Cell-specific linked CC |
| 7 | 0 ms | UE-specific linked CC |
| 8 | 10 ms | UE-specific linked CC |
| 9 | 30 ms | UE-specific linked CC |
| 10 | 90 ms | UE-specific linked CC |
| 11 | 160 ms | UE-specific linked CC |
| 12 | 320 ms | UE-specific linked CC |
| 13 | 960 ms | UE-specific linked CC |
| 14 | 960 ms | Primary component carrier (PCC) |
| 15 | 960 ms | Secondary component carriers (SCCs) |

With reference to Table 3, suspending objects of the indexes 0 to 6 of the suspending parameter 710 are UL CCs regarding particular cells, suspending objects of the indexes 7 to 13 of the suspending parameter 710 are UL CCs regarding particular cells, and suspending objects of the indexes 14 and 15 of the suspending parameter 710 are a primary component carrier (PCC) and one more secondary component carriers (SCCs).

Information regarding a UL CC regarding a particular cell (or a cell-specific linked CC) is received through system information (SI), and in particular, the information may be received through information in a second system information block (SIB2). Every MS does not perform a random access procedure through a UL CC regarding a particular cell during the suspending time indicated by the index.

Meanwhile, the Information regarding a UL CC regarding a particular cell (or a cell-specific linked CC) may be received through an RRC message. Then, the MS checks the cell-specific linked CC known through the RRC message, and does not perform a random access procedure through the cell-specific linked CC during a suspending time indicated by the index.

Also, if the MS receives the index 14, it does not perform the random access procedure through the UL PCC for 960 ms. For example, if a plurality of MSs including the MS set the same UL CC as a PCC, it may be difficult for the MSs to perform the random access procedure through the PCC. In this case, the plurality of MSs including the MS stop the random access using the PCC, and a failure probability of the random access can be reduced.

In addition, if the MS receives the index 15, it does not perform the random access procedure through the UL SCC for 960 ms. Thus, the plurality of MSs including the MS sets different uplink carriers as secondary CCs, and the random access procedure using the MS-specific secondary CC can be induced.

The mapping relationship between the indexes and the suspending time/suspending objects of the suspending parameter 710 may be previously known between the BS and the MS, or may be information provided by the BS to the MS.

The alternative carrier information 715 is information regarding a CC which may be used for performing a new random access if the current random access is suspended by the BS. When the MS receives the alternative carrier information 715, the MS can perform a new random access by using the alternative carrier information 715. The alternative carrier information 715 may be information recommended by the BS or may be information required by the BS for the MS to use a particular carrier. If the alternative carrier information 715 is recommended information, the MS may or may not use a carrier indicated by the alternative carrier information 715 and may voluntarily select a UL CC. The alternative carrier information 715 may indicate only one or more UL CCs.

Information regarding a random access suspension may not include the alternative carrier information 715. In this case, the MS may suspend the conventional random access using the UL CC and perform a new random access using a new UL CC arbitrarily selected by the MS.

If the alternative carrier information 715 is used, the MS can reduce an attempted repetition of a random access and the BS can directly select a preferred UL CC, so a delay time caused by a failure of a random access can be reduced, and the random access can be performed more quickly.

In the format of the information 700 regarding a random access suspension as shown in FIG. 7, the access suspension indicator 705, the suspending parameter 710 and the alternative carrier information 715 are disposed in this order, but this is merely illustrative and the disposition order of the respective information may be interchanged.

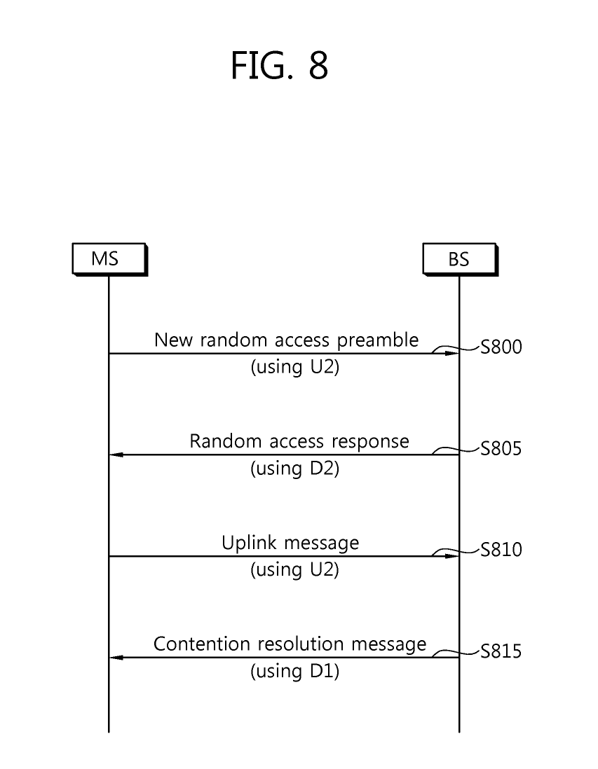

FIG. 8 is a flow chart illustrating a method for performing a random access according to an exemplary embodiment of the present invention. The process in FIG. 8 may correspond to a process following the blind decoding in FIG. 6.

With reference to FIG. 8, if an access suspension indicator is received from the BS, the MS refers to the alternative carrier information 715 and transmits a new random access preamble using the alternative carrier U2 to the BS (S800).

The BS transmits a random access response (RAR) to the MS by using D2 set to be linked to U2 (S805). When the RAR does not include information regarding any further random access suspension, the RAR may include TA information and an uplink grant for an uplink transmission.

Thus, the MS performs L2 or L3 uplink message transmission by using the TA information and the uplink grant (S810).

Then, the BS transmits a CR message for resolving a collision between a random access preamble by a different MS and the new random access preamble to the MS (S815). If the information regarding the CR carrier included in the RAR indicates D1, the BS transmits the CR message to the MS by using D1.

II. When RAR does not Include Information Regarding Random Access Suspension

In the information regarding the CR carrier, the CR carrier in FIG. 6 is D1. The DL CC transmitting scheduling information and the DL CC transmitting data indicated by the scheduling information may be different, and this is called cross CC scheduling.

According to the cross CC scheduling, the scheduling information regarding D3 is transmitted on D1, not on D3. Similarly, the CR message may be transmitted through a different DL CC, rather than through the DL CC on which the RAR was transmitted. In preparation for this, the BS informs the MS in advance about which of the DL CCs the CR message is to be transmitted.

The information regarding the CR carrier may be included in the PDCCH or may be included as a MAC or RRC message in the PDSCH. Or, the information regarding the CR carrier may be related to a DL CC previously agreed to between the BS and the MS.

For example, the previously agreed DL CC may be a DL PCC. In another example, the previously agreed DL CC may be a DL CC having the largest frequency bandwidth among DL CCs. In another example, the previously agreed DL CC may be a DL CC having the largest frequency bandwidth among activated DL CCs.

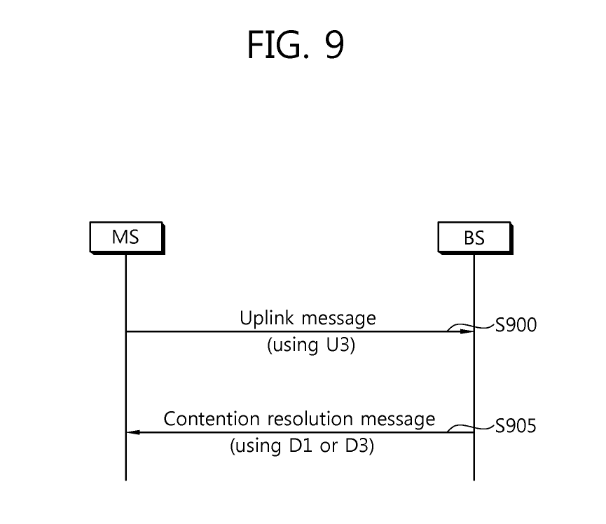

FIG. 9 is a flow chart illustrating a method for performing a random access according to an exemplary embodiment of the present invention. The process in FIG. 9 may correspond to a process following the blind decoding in FIG. 6.

With reference to FIG. 9, if the RAR does not include information regarding a random access suspension according to the decoding results in step S615 of FIG. 6, the RAR includes TA information and uplink grant required for an uplink transmission. The RAR may be a medium access control (MAC) protocol data unit (PDU).

Thus, the MS performs L2 or L3 uplink message transmission by using the TA information and the uplink grant (S900). The BS transmits a CR message to the MS (S905).

For example, the CR message may be transmitted by using a DL CC different from the DL CC through which the RAR was transmitted. When U3 and D3 are SCCs, if scheduling information of U3 and D3 is transmitted through D1, a PCC (cross CC scheduling), the BS transmits the CR message to the MS by using D1.

In another example, the CR message may be transmitted by using the DL CC through which the RAR was transmitted. If the scheduling information of U3 and D3 is transmitted through D3, the BS transmits the CR message to the MS by using D3.

If a random access is started as the BS transmits the PDCCH to the MS and the information in the PDCCH is used according to the PDCCH order, the CR message includes the MS information such as the C-RNTI information, the uplink grant, a new data transmission indicator, and information regarding an UL CC through which the MS has transmitted the random access preamble.

If a random access is started by the MAC layer of the MS, the CR message includes the MS information such as the C-RNTI information and the information regarding the UL CC through which the MS has transmitted the random access preamble.

Thereafter, the CR message received through the DL CC is decoded, and if the decoding operation is successfully performed, the MS transmits ACK to the BS, completing the random access procedure.

In this manner, since the MS checks the DL CC for transmitting the CR message, the random access can be performed even in the cross CC scheduling mode.

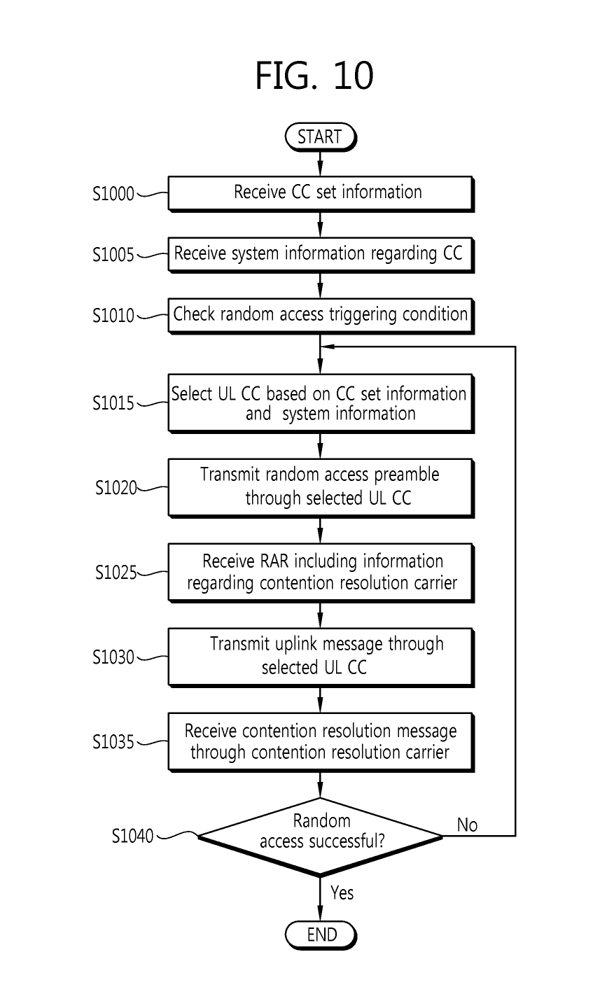

FIG. 10 is a flow chart illustrating a method for performing a random access according to an exemplary embodiment of the present invention. In this case, information regarding a random access suspension is not considered.

With reference to FIG. 10, the MS receives CC set information (S1000). The CC set refers to a set of CCs grouped through carrier aggregation. Information regarding the CC set may include an ID of a CC belonging to the CC set, index information indicating the corresponding CC, offset information indicating a different CC based on at least one CC, or the like. The information regarding the CC set may further include set ID information for distinguishing each CC set composed of one or more CCs.

The MS receives system information (SI) regarding a CC (S1005). The SI may include information regarding a method for configuring a linkage between uplink and downlink CCs in the MS, timing advance (TA) information for acquiring uplink synchronization. The SI may further include central frequency information regarding each CC in the CC set, and information regarding an overall frequency band of the corresponding CC. If there is a CC which cannot transmit SI among the CCs belonging to the CC set, e.g., if there is an extension CC (ECC), SI of the ECC may be converted to a CC which can receive the SI or into a control information format of a CC which can receive the SI, so as to be received. Or, the SI regarding the ECC may not be included. In this case, the MS may set a representative CC from the CC set information and the SI regarding the CC.

The MS checks whether or not a current condition is met to trigger a random access (S1010). When the condition for triggering a random access is met, the MS selects a UL CC through the received CC set information and the SI (S1015). The MS transmits a random access preamble to the BS using the selected UL CC (S1020).

The MS receives an RAR including information regarding a CR carrier from the BS (S1025). The MS transmits an uplink message through the selected UL CC (S1030). The uplink message is a message regarding L2 or L3. The MS receives a CR message from the BS through the CR carrier (S1035). The MS determines whether or not the random access has been successful (S1040). If the random access is successful, the MS terminates the random access procedure. Otherwise, the MS performs the process starting from step S1015.

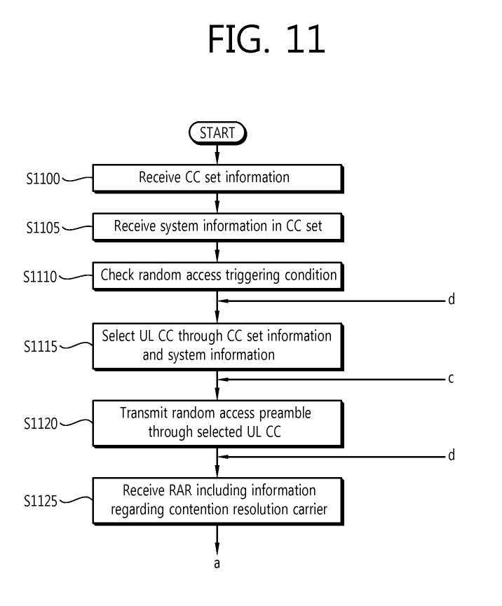

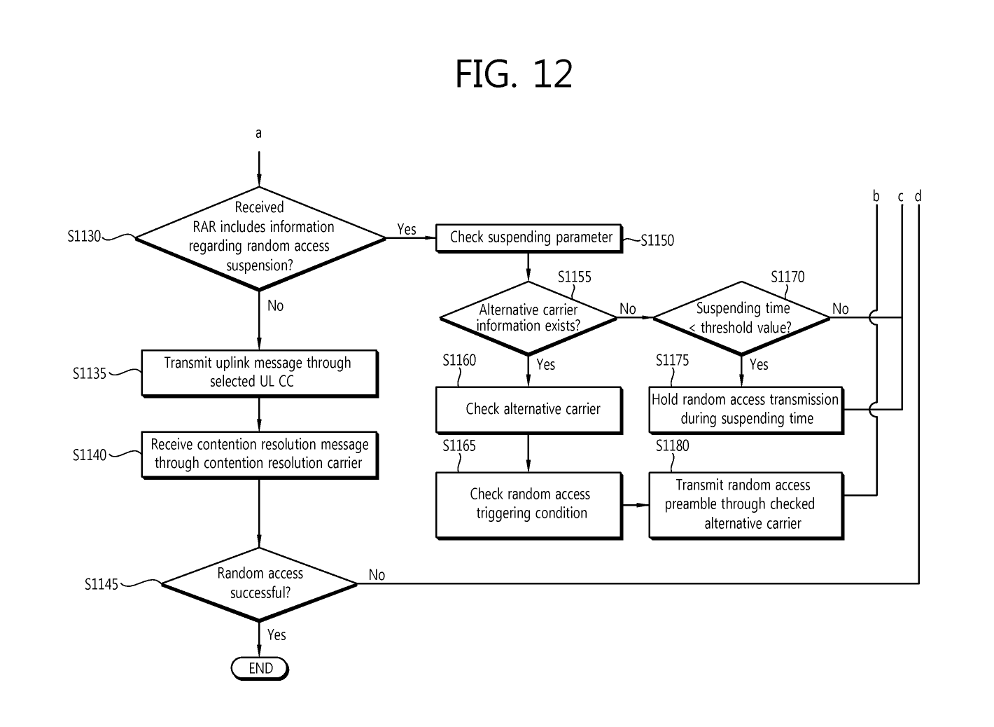

FIG. 11 is a flow chart illustrating a first portion of a method for performing a random access according to an exemplary embodiment of the present invention. FIG. 12 is a flow chart illustrating a second portion of the method of FIG. 11 for performing a random access according to an exemplary embodiment of the present invention. In this case, information regarding a random access suspension is considered.

With reference to FIG. 11 and FIG. 12, the MS receives CC set information (S1100). The CC set refers to a set of CCs grouped through carrier aggregation. The MS receives SI regarding a CC (S1105). The MS can set a CC from the SI regarding the CC. The MS checks whether or not a current condition is met to trigger a random access (S1110). When the condition for triggering a random access is met, the MS selects a UL CC based on the CC set information and the SI (S1115). The MS transmits a random access preamble to the BS by using the selected UL CC (S1120).

The MS receives an RAR including information regarding a CR carrier from the BS (S1025). The MS determines whether or not the received RAR includes information regarding a random access suspension (S1130).

If the received RAR does not include information regarding a random access suspension, the MS transmits an uplink message to the BS through the selected UL CC (S1135). And, the MS receives a CR message from the BS through a CR carrier (S1140). The MS determines whether or not the random access has been successful (S1145). If the random access is successful, the MS terminates the random access procedure. Otherwise, the MS repeats the selection of a UL CC based on the CC set information and the SI at step S1115.

When the received RAR includes information regarding a random access suspension in step S1130, the MS checks the information regarding the random access suspension (S1150). The information regarding the random access suspension includes at least one of an access suspension indicator, a suspending parameter, and alternative carrier information. The suspending parameter may include information regarding the suspending time and/or the suspending objects as described above and shown in Table 1, Table 2, and Table 3.

The MS determines whether or not the information regarding the random access suspension includes alternative carrier information (S1155). If alternative carrier information exists, the MS checks an alternative carrier indicated by the alternative carrier information (S1160) and checks the random access triggering condition again (S1165). Here, the random access triggering condition may be, for example, comparing the suspending time with a threshold value. For example, if the suspending time is greater than or equal to the threshold value, the triggering condition is considered to be met. If the random access triggering condition is met, the MS transmits a new random access preamble to the BS through the checked alternative carrier (S1180), and returns to step S1125.

If the alternative carrier information does not exist in step S1155, the MS checks the random access triggering condition again. In determining whether or not the triggering condition is met, the amount of data to be transmitted by the MS and the characteristics of the data may be considered. For example, the MS may check the triggering condition by determining whether or not the suspending time is smaller than the threshold value (S1170). If the suspending time is smaller than the threshold value, the random access triggering condition is not met, so the MS withholds a transmission of the random access preamble until the suspending time expires (S1175), and then, when the suspending time expires, the MS returns to step S1120.

Meanwhile, if the suspending time is not smaller than the threshold value, the random access triggering condition is met, so the MS transmits again the random access preamble through the selected UL CC (S1120).

The threshold value may be set according to the following method. For example, when the MS starts a random access in order to transmit a scheduling request, the MS checks the amount of transmission data and the type of the data through the UL CC. If the checked amount of transmission data is small or if the data is not sensitive to a delay time, the MS may set the threshold value to be higher. Meanwhile, if the amount of transmission data is large or the data is sensitive to the delay time, the MS may set the threshold value to be lower.

Checking the random access triggering condition is for the MS to perform a high speed random access in consideration of the amount of data to be transmitted and the data characteristics. Namely, the MS can check the suspension or holding of the random access during the suspending time, and this includes checking, by the MS, the suspending time, the amount of transmission data of the MS, and the data characteristics and performing a high speed random access by using the alternate CC through the checked alternative carrier information.

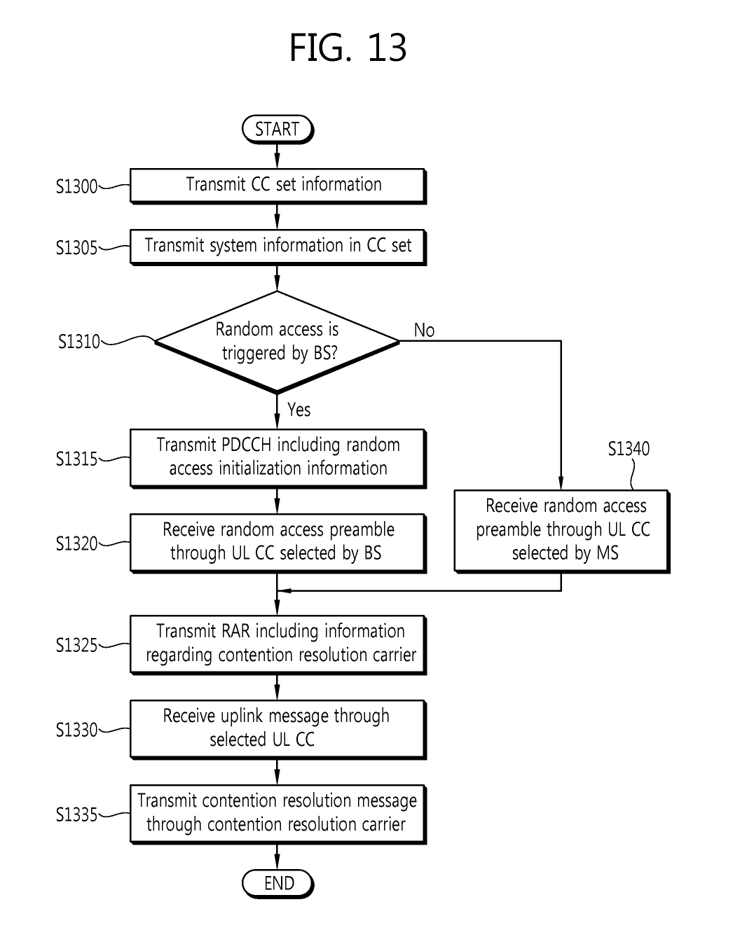

FIG. 13 is a flow chart illustrating a method for performing a random access according to an exemplary embodiment of the present invention. In this case, information regarding a random access suspension is not considered.

With reference to FIG. 13, the BS transmits CC set information to the MS (S1300). The BS transmits SI regarding a CC to the MS (S1305).

The BS checks whether or not the condition for triggering a random access is met (S1310). If the condition for triggering a random access is met, the BS transmits a PDCCH including random access initialization information to the MS by using the CC (S1315). The BS receives a random access preamble from the MS by using selected UL CC (S1320). The BS transmits an RAR including information regarding a CR carrier to the MS (S1325). The BS receives an uplink message from the MS through the selected UL CC (S1330). The BS transmits a CR message to the MS through the CR carrier (S1335).

If the condition for triggering a random access by the BS is not met in step S1310, a random access procedure started by the MS is performed. Thus, the BS receives a random access preamble through a UL CC selected by the MS (S1340) and performs the process starting from step S1325.

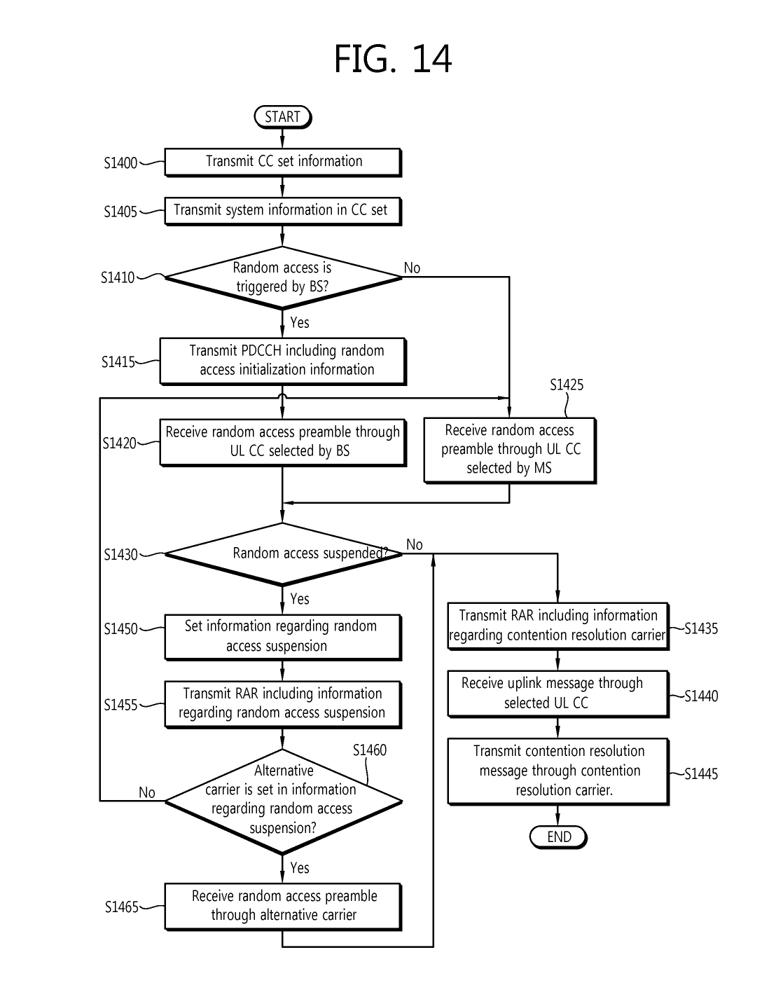

FIG. 14 is a flow chart illustrating a method for performing a random access according to an exemplary embodiment of the present invention. In this case, information regarding a random access suspension is considered.

With reference to FIG. 14, the BS transmits CC set information to the MS (S1400). The BS transmits SI regarding a CC to the MS (S1405).

The BS checks whether or not the condition for triggering a random access is met (S1410). If the condition for triggering a random access by the BS is met, the BS transmits a PDCCH including random access initialization information to the MS by using the CC (S1415). The BS receives a random access preamble from the MS by using selected UL CC (S1420).

When the condition for triggering a random access by the BS is not met in step S1410, a random access procedure started by the MS is performed. Thus, the BS receives a random access preamble through a UL CC selected by the MS (S1425).

The BS determines whether to suspend the random access (S1430). When the BS determines not to suspend the random access, the BS transmits an RAR including information regarding a CR carrier (S1435). The BS receives an uplink message from the MS through the selected UL CC (S1440). The BS transmits a CR message to the MS through the CR carrier (S1445), and then terminates the random access procedure.

When the BS determines to suspend the random access in step S1430, the BS sets information regarding the random access suspension (S1450). The BS transmits an RAR including the information regarding the random access suspension to the MS (S1455). The BS determines whether to set an alternative carrier in the information regarding the random access suspension (S1460). If the BS determines to set an alternative carrier in the information regarding the random access suspension, the BS receives a random access preamble from the MS through the alternative carrier (S1465). Thereafter, the BS performs step S1435.

If the BS determines not to set the alternative carrier in the information regarding the random access suspension in step S1460, the BS receives a random access preamble from the MS through the UL CC selected by the MS (S1425) and performs the process starting from step S1430.

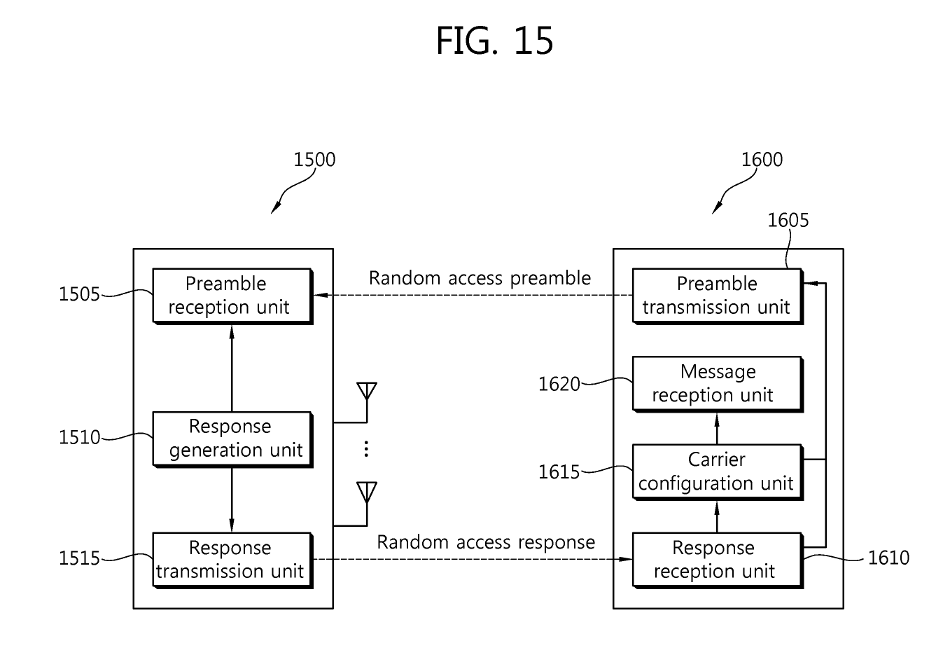

FIG. 15 is a schematic block diagram showing a BS and an MS to perform a random access according to an exemplary embodiment of the present invention.

With reference to FIG. 15, a BS 1500 includes a preamble reception unit 1505, a response generation unit 1510, and a response transmission unit 1515. An MS 1600 includes a preamble transmission unit 1605, a response reception unit 1610, a carrier configuration unit 1615, and a message reception unit 1620.

In the BS 1500, the preamble reception unit 1505 receives a first random access preamble for a first random access, on a first UL CC from the MS 1600. If the first random access of the MS 1600 fails, or if a random access is available through a second UL CC, the preamble reception unit 1505 may receive a second random access preamble for a second random access, on the second UL CC from the MS 1600. Also, the preamble reception unit 1505 receives an uplink message through the second UL CC from the MS 1600.

The response generation unit 1510 generates a random access response (RAR) including at least one of an access suspension indicator indicating whether or not the first random access is to be suspended, a suspending parameter, and information regarding a second UL CC to be used for the second random access if the first random access is suspended. The response generation unit 1510 may generate the RAR in the form of a MAC PDU. The suspending parameter may include, for example, the suspending time and/or suspending objects as described above and shown in Table 1, Table 2, and Table 3.

The response transmission unit 1515 transmits the RAR to the MS 1600 by using a first DL CC set to be linked to the first UL CC.

In the MS 1600, the preamble transmission unit 1605 transmits the first random access preamble to the BS 1500 through the first UL CC.

The response reception unit 1610 receives the RAR from the BS 1500 and transmits it to the preamble transmission unit 1605.

Meanwhile, the preamble transmission unit 1605 determines whether or not the information regarding the random access suspension included in the RAR includes alternative carrier information.

If the alternative carrier information exists, the preamble transmission unit 1605 checks an alternative carrier indicated by the alternative carrier information and checks a random access triggering condition. Here, the random access triggering condition may be, for example, comparing a suspending time with a threshold value. For example, if the suspending time is greater than or equal to the threshold value, the triggering condition is considered to be met. If the random access triggering condition is met, the preamble transmission unit 1605 transmits the second random access preamble to the BS 1500 through the checked alternative carrier (e.g., the second UL CC).

If the alternative carrier information does not exist, the preamble transmission unit 1605 checks the random access triggering condition again. In determining whether or not the triggering condition is met, the length of the suspending time, the amount of data to be transmitted by the MS and data characteristics may be considered. For example, the preamble transmission unit 1605 may check the triggering condition by determining whether or not the suspending time is smaller than the threshold value. If the suspending time is smaller than the threshold value, the random access triggering condition is not met, so the preamble transmission unit 1605 withholds a transmission of the second random access preamble until the suspending time expires, and then, when the suspending time expires, the preamble transmission unit 1605 may transmit the second random access preamble. Meanwhile, if the suspending time is not smaller than the threshold value, the random access triggering condition is met, so the preamble transmission unit 1605 transmits again the random access preamble through the selected UL CC.

The carrier configuration unit 1615 sets the second DL CC in the terminal 1600 based on a CC set.

The message reception unit 1620 receives a contention resolution (CR) message for resolving a collision between a random access preamble by a different MS and the random access preamble from the BS 1500 by using the set second DL CC. Also, the message reception unit 1620 receives CC set information from the BS 1500. The CC set refers to a set of CCs grouped through carrier aggregation. Information regarding the CC set may include an ID of a CC belonging to the CC set, index information indicating the corresponding CC, offset information indicating a different CC based on at least one CC, or the like. The information regarding the CC set may further include set ID information for distinguishing each CC set composed of one or more CCs.

According to exemplary embodiments of the present invention, an MS can reduce a repetition of an unsuccessful random access and shorten a delay time caused by a failure of a random access. Also, a random access can be applicable even when control information such as scheduling information and data are transmitted through different carriers.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for performing a random access by a mobile station in a multi-carrier system, the method comprising:
transmitting a first random access preamble on a first uplink (UL) component carrier (CC) to a base station (BS); and
receiving a random access response (RAR) on a first downlink (DL) CC linked to the first UL CC,
wherein the RAR comprises information regarding a second DL CC, and the second DL CC is used to transmit a contention resolution (CR) message indicating that a random access collision with other mobile stations are resolved.

2. The method of claim 1, wherein the second DL CC is a primary CC (PCC) and the first DL CC is a secondary CC (SCC).

3. The method of claim 1, wherein the RAR comprises information regarding a random access suspension, and the information regarding the random access suspension comprises alternative carrier information indicating the second UL CC.

4. The method of claim 3, wherein the information regarding the random access suspension further comprises one of a suspending parameter, a type discrimination indicator indicating whether a random access preamble identifier is includes or not, and an access suspension indicator indicating whether the random access suspension includes or not; and
wherein the information regarding the random access suspension is configured as a medium access control (MAC) message subheader.

5. The method of claim 4, wherein the suspending parameter comprises information regarding a suspending time or information regarding a combination of the suspending time and a suspending object, and the suspending time indicates a duration for suspending the second random access,
wherein the suspending object indicates a CC or a cell in which the second random access is suspended, and
wherein each of the information regarding the combination of the suspending time and the suspending object and the information regarding the suspending time is configured specifically to a CC or to the mobile station.

6. The method of claim 4, wherein each of the information regarding the combination of the suspending time and the suspending object and the information regarding the suspending time is configured specifically to a primary CC (PCC).

7. The method of claim 4, wherein each of the information regarding the combination of the suspending time and the suspending object and the information regarding the suspending time is configured specifically to a secondary CC (SCC).

8. The method of claim 4, wherein the information regarding the random access suspending further comprises a suspending parameter, and the suspending parameter is configured Cell-specific linked CC.

9. The method of claim 4, wherein the information regarding the suspension of the random access further comprises a suspending parameter, and the suspending parameter is configured UE-specific linked CC.

10. The method of claim 4, further comprising:
checking if a triggering condition for triggering a second random access is met; and
if the triggering condition is met, transmitting a second random access preamble to the BS through a second UL CC.

11. A method for performing a random access by a base station (BS) in a multi-carrier system, the method comprising:
receiving a first random access preamble on an uplink (UL) component carrier (CC) from a first mobile station (MS);
transmitting a random access response (RAR) on a first downlink (DL) CC linked to the UL CC;
receiving an uplink message from the first MS on a UL resource indicated by the RAR; and
transmitting a contention resolution (CR) message on a second DL CC, the CR message indicating that a collision of the first random access preamble and a second random access preamble of other MSs are resolved,
wherein the RAR comprises information regarding the second DL CC.

12. The method of claim 11, wherein the RAR comprises timing advance (TA) information and an uplink grant, and the uplink message is received based on the TA information and the uplink grant.

13. A base station (BS) to perform a random access in a multi-carrier system, the BS comprising:
a preamble reception unit to receive a first random access preamble on a first uplink (UL) component carrier (CC) from a first mobile station (MS) performing a first random access;
a response generation unit to generate a random access response (RAR) comprising first information and second information, the first information to suspend a second random access if the first random access is not successful, the second information identifying a second UL CC to perform the second random access if the second random access is triggered; and
a response transmission unit to transmit the RAR to the first MS by using a first downlink (DL) CC linked to the first UL CC.

14. The base station of claim 13, wherein the preamble reception unit receives a second random access preamble from the first MS if the second random access is triggered.

15. The base station of claim 13, wherein the base station sends a contention resolution (CR) message on the second DL CC if a collision of the first random access preamble and a third random access preamble of a second MS is resolved.

16. A first mobile station (MS) to perform a random access in a multi-carrier system, the first MS comprising:
a preamble transmission unit to transmit a first random access preamble on a first uplink (UL) component carrier (CC) to a base station (BS);
a response reception unit to receive a random access response (RAR) on a first downlink (DL) CC linked to the first UL CC;
a carrier configuration unit to configure a second DL CC; and
a message reception unit to receive a contention resolution (CR) message on the second DL CC, the CR message indicating a resolution of a collision of the first random access preamble and a second random access preamble of a second MS, wherein the RAR comprises information regarding the second DL CC.

17. The first MS of claim 16, wherein if a triggering condition for triggering a third random access is met, the preamble transmission unit transmits a third random access preamble to the BS through a third UL CC.

18. The first MS of claim 16, wherein the RAR comprises a suspending parameter indicating a suspending time of the third random access, and further comprises alternative carrier information indicating the third UL CC.
